(19) United States
(12) Patent Application Publication
(10) Pub. No.: US 2013/0209898 A1
(43) Pub. Date: Aug. 15, 2013

(54) MESOSTRUCTURED THIN-FILMS AS ELECTROCATALYSTS WITH TUNABLE COMPOSITIONS AND SURFACE MORPHOLOGY

(71) Applicants: Vojislav Stamenkovic, Naperville, IL (US); Nenad Markovic, Hinsdale, IL (US)

(72) Inventors: Vojislav Stamenkovic, Naperville, IL (US); Nenad Markovic, Hinsdale, IL (US)

(21) Appl. No.: 13/800,707

(22) Filed: Mar. 13, 2013

Related U.S. Application Data
(63) Continuation-in-part of application No. 13/451,852, filed on Apr. 20, 2012.
(60) Provisional application No. 61/541,943, filed on Sep. 30, 2011.

(51) Int. Cl. H01M 4/92

(52) U.S. Cl. CPC H01M 4/921
USPC 429/405; 502/339; 502/185; 502/326; 502/5; 502/325; 429/524

(57) ABSTRACT

A composition of matter and method of manufacturing as thin film electrocatalyst. The method uses physical vapor deposition to deposit a thin film of PtM (Ma transition metal) to form a Pt based alloy and annealing the thin film to achieve a (111) hexagonal faceted grain structure having catalytic activity approaching Pt₃Ni (111) skin.

### CROSS-REFERENCE TO RELATED APPLICATIONS

This application is a continuation in part of, and claims priority to, Utility patent Ser. No. 13/451,852 filed Apr. 20, 2012 which claims priority to U.S. Provisional Patent Application No. 61/541,943 filed Sep. 30, 2011, all of which are incorporated by reference herein in their entirety.

### STATEMENT OF GOVERNMENT INTEREST

The U.S. Government claims certain rights in this invention pursuant to Contract No. DE-AC02-06CH11357 between the U.S. Department of Energy and UChicago Argonne, LLC, representing Argonne National Laboratory.

### FIELD OF THE INVENTION

The present invention relates generally to thin film electrocatalysts and more particularly relates to thin film electrocatalysts having tunable compositions and controllable surface phases and crystalline morphology for improved catalytic performance.

### BACKGROUND OF THE INVENTION

This section is intended to provide a background or content to the invention that is recited in the claims. This description herein may include concepts that could be pursued, but are not necessarily ones that have been previously conceived or pursued. Therefore, unless otherwise indicated herein, the concepts described in this section are not prior art to the description and claims in this application and are not admitted to be prior art by inclusion in this section.

Over the past decades, extensive research has been devoted to the development of technologies that can effectively convert energy and become economically viable for use by the general public. Great expectations are held for technologies such as fuel cells and lithium—air batteries that rely on electrochemical processes. In both cases, satisfactory energy density can be attained; however, a major challenge lies in the insufficient activity and durability of the materials that are employed at present as cathode catalysts for electrochemical reduction of oxygen. These limitations inevitably lead to a lower operating efficiency of the devices, which highlights the need for the development of more active and durable oxygen reduction reaction (hereinafter “ORR”) catalysts. In the case of fuel cells, most of the research centers on platinum, the best monometallic catalyst for the ORR. At the present state of development, an approximately fivefold reduction in Pt content is necessary to meet cost requirements for large-scale automotive applications. Pt-based alloys have already made an impact in fuel-cell catalyst design by decreasing the amount of platinum while improving activity and durability, which places these materials at the focus of intensive fundamental and applied research on both extended (bulk)' and nanoscale systems. The main challenge in that effort is linked to the possibility of achieving the unique structural and compositional profile of Pt₃Ni(111) alloys, which was established from single-crystal studies. This profile was obtained on extended surfaces by thermal annealing that facilitates thermodynamically driven segregation of Pt to form a pure ordered surface layer, denoted as Pt(111)-skin. The electronic structure of Pt(111)-skin is altered by the subsurface layer of PtNi (in 1:1 ratio) and is responsible for the extreme ORR activity, which is nearly two orders of magnitude higher than the state-of-the-art Pt/C catalyst. Consequently, the ability to mimic the compositional profile and structure of Pt-skin in high-surface-area catalysts would bring unprecedented benefits to technologies that rely on the ORR. However, despite numerous attempts, this goal has not been achieved yet for practical catalysts.

### SUMMARY OF THE INVENTION

Various aspects of the invention are directed to compositions and methods for preparing platinum-based alloys to provide mesostructured thin films as electrocatalysts. These compositions represent an improved class of materials based on mesostructured multimetallic thin films with adjustable structure and composition, which have been tailored to emulate the distinctive properties of a Pt(111)-skin, to be employed in electrochemical devices and other applications. These catalysts can bridge the world of extended surfaces with superior activity and nanoscale systems with high specific surface area in order to harvest maximal utilization of precious metals such as, but not limited to, Pt based alloys. These principals can be applied to other such Pt group metal systems, like Pd and Rh. Such synergy is foreseen to be present at the mesoscale, which implies not only a specific length scale, but rather a principle of operating in between different physical regimes that exhibit distinct functional behaviour. In particular, for electrocatalytic materials, most previous work has emphasized either achievement of high surface area through small particle size, or the attainment of a better understanding of fundamental properties through the use of extended surfaces. From such studies, it is well known that there are substantial differences in catalytic properties between nanoscale and bulk materials. The benefits of targeting mesoscale architectures between these extremes have not been adequately explored, especially in the sense of transferring superior characteristics from extended surfaces to practical materials. In view of that, instead of using discrete nanoparticles (3-5 nm) supported on high-surface-area carbon, continuous Pt and Pt-alloy nanostructured thin films (hereinafter “NSTF”) were most preferably disposed over an oriented array of molecular solid whiskers by physical vapor deposition. Specifically, planar magnetron sputter deposition was most preferably used to deposit thin metal films with a wide range in composition. Such NSTF catalysts provide good surface area utilization and eliminate issues related to carbon-support corrosion and contact resistance at the carbon/metal interface that would lead to poor utilization and degradation of the catalyst. In a most preferred embodiment, the capability to control the deposition rate, as well as the combination and order of constituents, makes sputter deposition an effective tool to form thin films with desirable thickness, composition profile and surface roughness. A thorough examination of thin-film properties was performed on extended, flat, non-crystalline and chemically inert substrates such as a mirror-polished glassy carbon surface. These methods enable an extra level of control in terms of defined geometric surface area and surface roughness factor that is unattainable in the case of nanoscale substrates.

These and other features of the invention, together with the organization and manner of operation thereof, will become apparent from the following detailed description when taken in conjunction with the accompanying drawings, wherein like elements have like numerals throughout the several drawings described hereinbelow.

### BRIEF DESCRIPTION OF THE DRAWINGS

FIG. 1a illustrates cyclic voltammograms (hereinafter “CV”) and STM images of Pt 20 nm thin layers as deposited and (111) films deposited on a glossy carbon substrate; FIG. 1b illustrates CV and STM images of annealed Pt film and Pt(111); FIG. 1c shows a CV profile of as deposited PtNi (“b”) film, annealed PtNi film (“r”) and Pt₃Ni (111) skin and FIG. 1d shows specific activities measured by RDE in 0.1M HClO₄ with 1600 rpm, 20 mVs⁻¹ at 0.95V with corresponding improvement factors versus polycrystalline Pt;

FIG. 2a(1) illustrates schematically a starting substrate, FIG. 2a(2) shows a schematic of physical vapor deposition, FIG. 2a(3) shows a resulting HSREM snapshot (corresponding to FIG. 2a(2)) of a group of whiskers including length, shape and alignment after deposition of the thin films and FIG. 2a(4) shows a schematic corresponding to FIG. 2a(3); FIG. 2b shows an HRSEM image close-up of an intentionally broken single whisker demonstrating thickness of the metallic film over a perylene red substrate; FIG. 2c shows an HRTEM close-up of a single whisker side showing whiskerette (sub-whiskers on each whisker) growth along the whisker; FIG. 2d shows on HRTEM image close-up of a whisker surface with a close packed formation of whiskerette tips of 5 nm diameter which provides a highly corrugated morphology; and FIG. 2e shows a TEM micrograph of a whisker side that confirms grain texture of the sputtered thin film and shows representative diameters of the whiskerettes;

FIG. 3a(1) shows a side schematic view and HRSEM image of whiskers of a nanostructure thin film at the beginning of an anneal cycle; FIG. 3a(2) shows an HRTEM low magnification image of one of the whiskers before annealing and FIG. 3a(3) shows that same image but at higher magnification; FIG. 3b(1) shows a side schematic view and an HRSEM image of whiskers after annealing at 400° C. has started and showing surface modification and evaporation, FIG. 3b(2) shows an HRTEM low magnification image of one of the whiskers after annealing has started and FIG. 3b(3) shows a higher magnification view of FIG. 3b(2) showing flattening and smoothing of the surface morphology; and FIG. 3c(1) shows after annealing has completed for a side schematic view and HRSEM image of whiskers to form mesostructured thin films on the whiskers; FIG. 3c(2) shows an HRTEM low magnification image of one of the whiskers after annealing with clearly observable grain morphology and a smoother/flatter surface texture; and FIG. 3c(3) shows a higher magnification HRTEM image of FIG. 3c(2);

FIG. 4a shows CV plots for Pt-NSTF, PtNi-NSTF and PtNi-Meso-TF; FIG. 4b shows ORR polarized curves for the materials of FIG. 4a; FIG. 4c shows corresponding Tafel plots for two materials wherein Tafel slopes are determined at potentials higher than half-wave potential (E_{1/2}: potential and which l=1/2 l_{diff}) to avoid diffusion and solution resistance induced errors; and FIG. 4d shows specific activities measured at 0.95V and an improvement factor versus Pt-poly (and Pt-NTSF); and

FIG. 5 illustrates an activity map for ORR obtained for different classes of Pt-based materials with improvement factors given on the basis of activities compared with values for polycrystalline Pt and state of art Pt/C catalyst systems established by RDS measurements in 0.1 MHClO₄ at 0.95V.

### DETAILED DESCRIPTION OF PREFERRED EMBODIMENTS

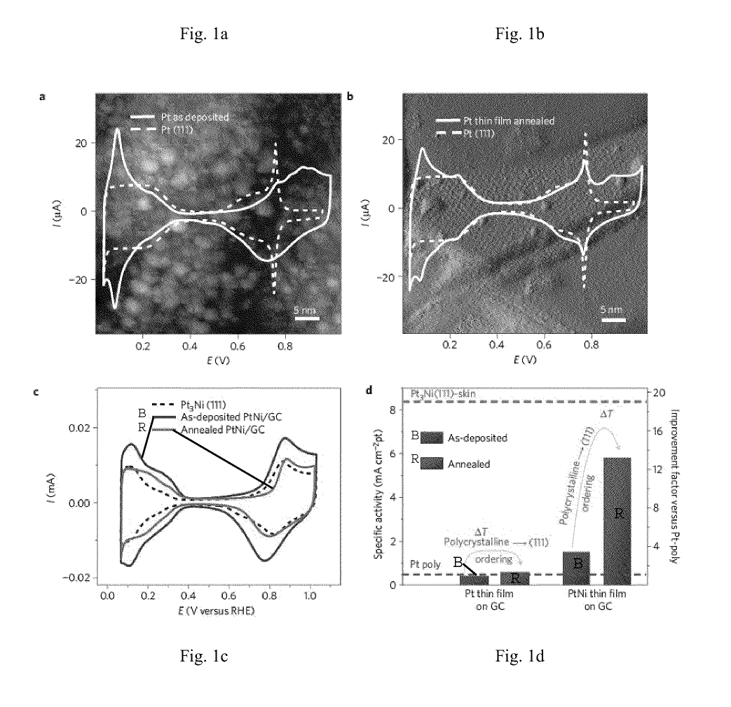

In a preferred method of the invention, various Pt based materials were processed to provide a mesostructured thin film. In a first step, a deposition was performed of a pure Pt thin film onto an ultrahigh-vacuum-cleaned glassy carbon substrate, which was followed by thermal annealing in a reductive atmosphere. The details of several examples of preferred methods of processing and analyzing are provided hereinafter in the Examples section. The morphology of the Pt film was validated by scanning tunneling microscopy (STM) as shown in FIGS. 1a and 1b. The difference between as-deposited versus annealed Pt films indicates a substantial change in the thin-film surface morphology due to rearrangement of the Pt topmost atoms towards the (111) structure with a minimum surface energy. The as-deposited Pt film has a corrugated nanostructured three-dimensional surface morphology with an average grain size of ˜5 nm, whereas the morphology of the annealed thin film has been transformed into a smooth two-dimensional surface with large 20×100 nm hexagonal (111) facets. In accordance with the STM results, the characteristic surface features are also confirmed by electrochemical cyclic voltammetry (CV). FIG. 1a reveals that the CV profile of the as-deposited thin-film surface matches the one established for bulk polycrystalline Pt. On the other hand, FIG. 1b shows that the CV profile of the annealed Pt thin film underwent extensive transformation from typical polycrystalline into Pt(111)-like with characteristic fingerprint features between 0.5 and 0.9 V; the so-called butterfly region that corresponds to adsorption/desorption processes of 0H_{ad} on Pt(111) facets. Therefore, it is evident from both STM and CV that the annealed, extended thin film consists of predominantly (111) facets encompassing the entire surface. In fact, the degree of resemblance in electrochemical signature between the annealed thin-film surface and single-crystal Pt confirms that the (111) facets are both large and interconnected. The synergy between the surface structure, domain size and functionality establishes that the thin-film surface has a distinct mesostructured morphology. These findings clearly demonstrate the feasibility of controlling surface ordering of extended Pt based thin films deposited over a non-crystalline substrate, that is, without the use of templates for epitaxial growth. Instead of building the crystal lattice from a seed or underlying crystalline substrate, individual randomly oriented nanoscale grains coalesce and form large well-ordered (111) facets. These features greatly expand the potential for utilization of thin-film materials and enables particular types of thermal annealing in a controlled atmosphere as a useful tool in the fine tuning of a thin film's structure and hence electrocatalytic properties.

In the following described preferred preparation steps a bimetallic PtNi thin film is prepared with the same thickness to mimic the composition profile of the Pt₃Ni(111) single crystal system and to replicate its catalytic properties. The results from the electrochemical measurements in FIGS. 1c and 1d confirm that as for monometallic Pt, the polycrystalline nature of the as-deposited alloy thin film is predominantly transformed into a Pt(111)-skin-like surface. This is clear from both the CV profile of the annealed alloy thin film that substantially resembles the one obtained on Pt₃Ni(111) and results in superior catalytic activity for the ORR, which was up to now obtained exclusively on the Pt₃Ni(111)-skin surface. The combination of the Pt(111)-skin like voltammetry and the marked increase in the ORR activity proves that surface ordering from randomly oriented towards (111) is indeed feasible for bimetallic thin films. This also demonstrates that the catalytic improvement follows the same basic mechanism as previously reported for Pt-bimetallic single-crystal surfaces; that is, electronic modification of the topmost Pt layer leads to greatly improved catalytic enhancement solely for the (111) type of orientation. Therefore, the ORR-specific activity, which equals about 70% of the value established for the most active catalyst, Pt₃Ni(111)-skin, serves as an indicator that (111)-skin facets are dominating on the annealed thin-film surface. Together this demonstrates the advantageous features of controlled annealing in facilitating the formation of the mesostructured Pt based alloy thin film morphology, characterized by both an energetically more favorable surface state rich in (111) facets, and a desired compositional profile.

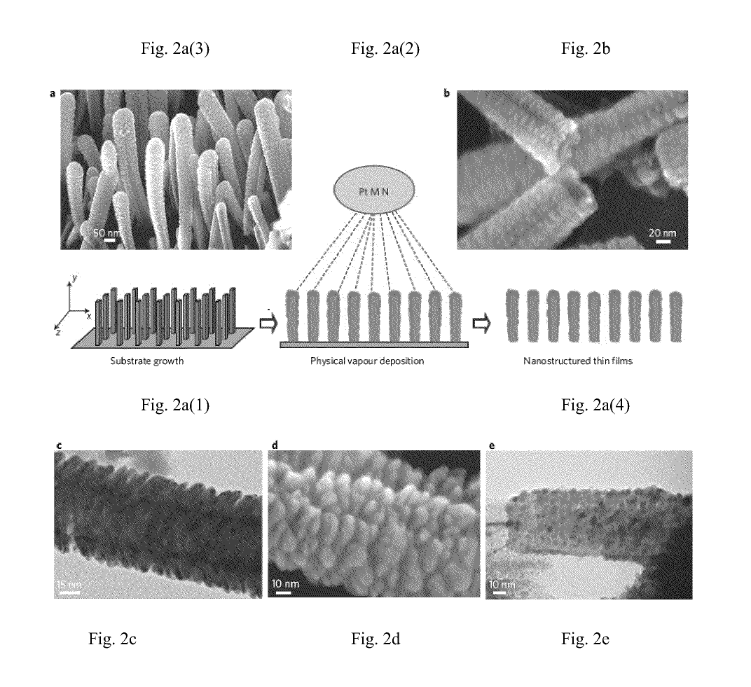

These results indicate the substantial advantages towards achieving mesostructured corresponding thin-film-based high-surface-area materials from the Pt group metals having greatly improved catalytic properties. In one illustrative example of a preferred embodiment, Pt-alloy NSTF catalyst is deposited by magnetron sputtering over an array of molecular solid whiskers, composed of an organic pigment N, N-di(3,5-xylyl)perylene-3,4:9,10 bis(dicarboximide); hereinafter denoted as perylene red. FIGS. 2a(1)-2e illustrate a step-by-step deposition process and analytical results for the thin metal films deposited and processed onto a perylene red support. Also shown are high-resolution scanning electron microscopy (HRSEM) and transmission electron microscopy (TEM) micrographs of the NSTF whiskers. These images reveal insight into critical parameters of the NSTF such as metallic film thickness, length, shape and surface morphology. A single whisker measures on average about 800 nm in length, and the film thickness is about 5-20 nm. In FIGS. 2c-2e, the sides of a single whisker are quite clearly shown, smaller metal alloy whiskerettes are formed on each of the whiskers and have a diameter of ˜5 nm (FIG. 2c), and a close-up of a broken whisker (FIG. 2e) illustrates the metallic film/shell that surrounds the perylene red substrate. Surface-specific HRSEM in FIGS. 2b-2e shows that the side walls along the whisker have a very rough surface morphology, consisting mainly of whiskerette tips bonded closely to each other to produce densely packed corncob-like features, providing the validity of terming this material a NSTF. It is important to note that the highly grained texture of the NSTF side walls made of closely packed whiskerettes is also confirmed in the TEM micrograph in FIG. 2e. Such structural parameters and morphologies greatly affect the functional properties of the NSTF, and therefore the ability to control and tune them along with the near-surface compositional profile can lead towards a substantial gain in catalytic performance.

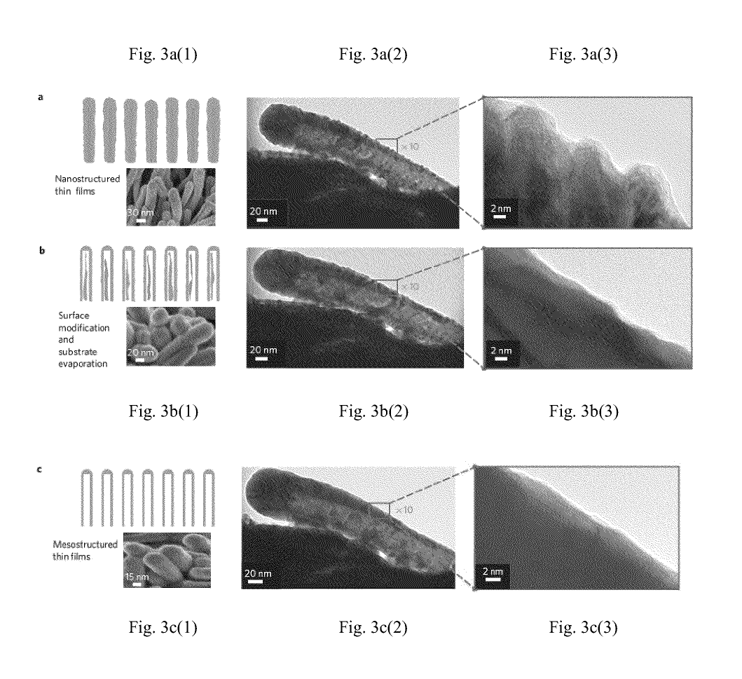

In the following description a preferred methodology is combined with the knowledge related to highly active well-defined single crystalline and extended thin-film surfaces to develop mesostructured thin-film electrocatalysts with advanced properties. In situ HRSEM and TEM are simultaneously employed during NSTF annealing in a controlled atmosphere. This allows us to visualize real-time structural changes at and near the atomic level and to follow rearrangements of the surface and sub-surface morphology of thin-film materials. This insight is invaluable in the fine-tuning of the materials' properties. FIGS. 3a(1)-3c(3) show in situ results obtained during thermal annealing of a single PtNi-NSTF whisker. The NSTF catalyst is mounted onto the HRTEM heating stage and is introduced to a reductive atmosphere of argon and hydrogen gases. As the specimen is initially heated, no change in surface morphology is observed as depicted in FIG. 3a(1)-3a(3). These images show the initial stage and a close-up of the grained highly corrugated whisker side wall and its surface. Once the temperature reaches about 300° C., real-time restructuring occurs for the thin film's morphology. FIGS. 3b(1)-3b(3) capture the onset of the surface transformation, which appears as a smoothening of the near-surface regions. The steady-state structure is achieved after only about 30 minutes and is shown in FIGS. 3c(1)-3c(3). These images illustrate that the densely packed organization with the initial three-dimensional surface morphology is being rapidly transformed into a more homogeneous, flat and ordered two-dimensional thin-film material with clearly observable crystalline morphological features present in its exterior surface walls. This thermodynamically driven transition releases stress and strain of the as-deposited thin film and leads towards a state with minimum surface energy without compromising the overall shape and dimension of the whisker. As for Pt thin films on glassy carbon, the initial nanostructured surface morphology that originated from the closely bonded whiskerettes' tips is transformed into a smooth continuous film with large crystalline domains (about 20-40 nm). Specifically, randomly oriented nanoscale grains coalesce and give rise to a mesostructured thin film with unique physicochemical properties; therefore, the materials after this treatment will be referred to as mesostructured thin films (Meso-TF). Close inspection of the HRTEM micrographs of FIGS. 3c(2) and 3c(3), after applied thermal treatment, confirms that emerged facets have a (111) structure and prevail on the surface whereas under coordinated sites are diminished, which also has important implications towards improved stability. As a side effect, the perylene red substrate is removed during this procedure. In addition to HRTEM/SEM studies, X-ray diffraction measurements, which show enhanced alloying and an increase in the number of (111)-oriented domains on the Meso-TF, are presented in the Supplementary Information.

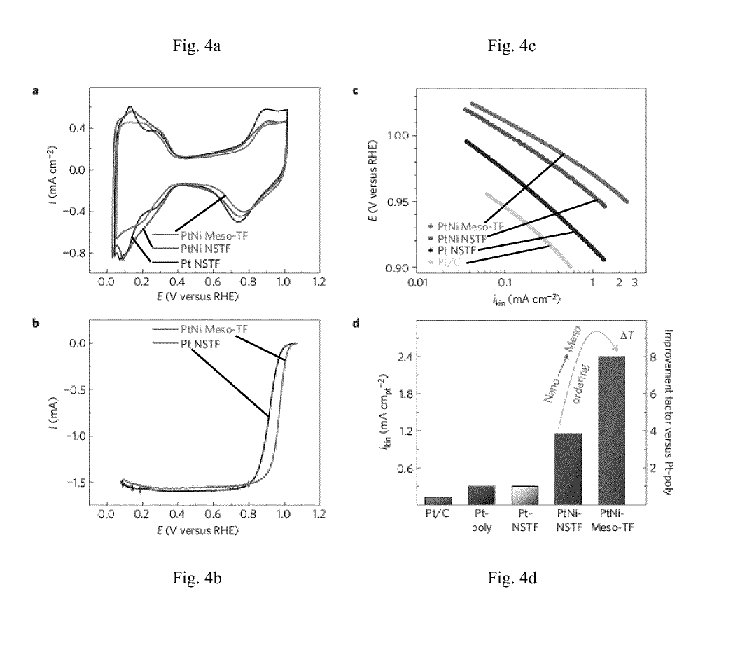

The final step in the characterization is to obtain the electrochemical signature and compare adsorption and catalytic properties between different classes of thin-film materials and the state-of-the-art Pt/C catalyst by rotating-disc electrode (RDE) (see Example I). As expected, from the CV profile depicted in FIGS. 4a-4d the smooth morphology of the Meso-TF slightly lowers the electrochemically active surface area (ECSA), from ˜11 m² g⁻¹ for the NSTF to ˜9 m²g_{Pt}⁻¹ for the Meso-TF. This implies that most of the inner portion of the whiskers, which has been vacated by the perylene red, is not electrochemically active, presumably owing to lack of penetration of the electrolyte into the hollow of the whisker (see closed whisker ends in FIGS. 3a(1) to 3a(3)). As shown in FIG. 4a, the CV profile of PtNi NSTF whiskers exhibits similar behaviour to monometallic Pt NSTF with clearly visible polycrystalline Pt features due to the adsorption—desorption processes of underpotentially deposited hydrogen (H_{upd}). However, the Hᵤₚ region of PtNi Meso-TF is significantly different with a characteristic flat plateau (see FIG. 4a), which confirms that the surface has a relatively large contribution of (111) facets compared with the highly corrugated sputtered thin film that is rich in low-coordinated Pt sites. This is also in good agreement with HRTEM and X-ray diffraction results. Moreover, the onset of surface oxide formation is shifted positively in the following order: Pt-NSTF<PtNi-NSTF<PtNi Meso-TF. Accordingly, the ORR polarization curves, shown in FIG. 4b, follow the same trend in activity. FIGS. 4c and 4d summarize the kinetic current densities (specific activities per ECSA of Pt) as Tafel plots and a bar graph, respectively. Specific activity is a fundamental property of a material that reflects its intrinsic catalytic performance, as opposed to mass activity, which emphasizes the optimized dispersion of a material. Consequently, the focus has been placed on boosting specific activity. This approach leads to a higher turnover frequency (the measure of activity per active site), which should result in better utilization of Pt, culminating in higher mass activity. Considering the large increase in specific activity, values are measured at 0.95 V to avoid diffusion-induced errors in kinetic current densities. The order of specific activity becomes apparent, with Pt/C being the least active, followed by Pt-NSTF and polycrystalline Pt. One can observe a significant increase in activity for PtNi Meso-TF, accompanied by a decrease in Tafel slope from ˜70 mV dec⁻¹ for monometallic Pt to ˜40 mV dec⁻¹ . This value is considerably lower than those commonly reported for Pt-based catalysts in the literature, but it is in line with the value obtained on Pt₃Ni( )-skin′ The activity of PtNi Meso-TF exhibits an improvement factor of over 8 versus Pt-poly and Pt-NSTF. Furthermore, when compared with the state-of-the-art conventional Pt/C catalyst, the specific activity of the PtNi Meso-TF achieves an unprecedented 20-fold enhancement. The measured improvement expressed in A/mgp, corresponds to a mass activity that is already three times higher than the US Department of Energy technical target t². Together, the flat voltammetric curves, the trend in specific activity, the low Tafel slope and the structural characterizations indicate that the annealed PtNi Meso-TF has a Pt-skin-type near-surface structure.

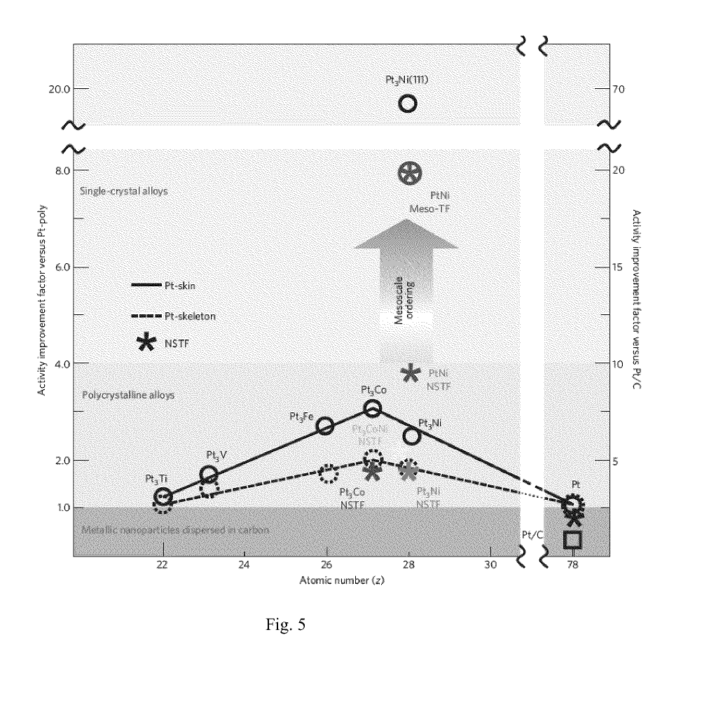

As shown in FIG. 5, the findings on thin-film-based mesostructured catalysts are merged into the same chart with nanoscale systems and bulk materials. In FIG. 5, the ORR activity map is shown for different classes of Pt alloys, that is, from nanoparticles dispersed on high-surface-area carbon, to polycrystalline bulk materials and to single-crystalline alloys of Pt₃Ni(hkl) surfaces'. This map shows a huge span in intrinsic specific activities among materials of the same bulk elemental composition that differ in form and surface structure. It also demonstrates the importance of controlling fundamental properties that determine catalytic performance. Specifically, the ability to alter physical parameters such as particle size, near-surface composition profile, morphology and surface structure can lead to substantial improvements in functional properties of real commercial catalysts. Notably, a number of NSTF catalysts with different compositions are summarized in FIG. 5; however, for the sake of brevity investigated only the results for the PtNi are shown in detail; but it is understood that the principals described herein can be applied to Pt group based alloys (such as Pd and Rh) combined with transition metals M, which are known to form desired alloys readily with Pt group metals. The activity values are thus given for exemplary Pt alloys with different example transition metals associated with the atomic number (Z). The main features in FIG. 5 are designated activity regions for different classes of materials. Metallic nanoparticles of Pt and Pt alloys dispersed on a high-surface-area carbon support exhibit profoundly lower activities compared with their polycrystalline bulk counterparts. The assigned region that reflects the activity range of metallic nanoparticles is based on the literature data reported for Pt-alloys obtained by conventional impregnation methods. The next level in activity is reserved for extended bulk polycrystalline systems, where the specific activity of Pt₃M-alloys can be improved by a factor of three versus Pt-poly. As mentioned above, the capability to control the surface structure leads to an extra boost in activity, and hence the highest ORR activity ever measured was obtained for the Pt₃Ni(111)-skin surface.

On the basis of the values depicted in FIG. 5, the NSTF catalysts can successfully mimic the catalytic behaviour of polycrystalline bulk materials, while Pt-alloy mesostructured thin films exceed the range designated for polycrystalline systems. This is the first practical catalyst alloy system and preparation method which can approach the levels of activity previously reserved only for bulk single-crystalline surfaces, owing to the formation of a surface and near-surface structure similar to that of the ideal Pt,Ni(111)-skin. These bimetallic Meso-TF materials preserve sufficiently high specific surface area, which enables better utilization of precious metals. Moreover, Pt-based catalysts with mesoscale features also avoid the activity losses that are caused by the higher fraction of low-coordinated surface atoms that are present in nanoscale catalysts. Consequently, thin-film electrocatalysts are hampered neither by the stability issues that accompany the use of high-surface-area carbon support, nor by the loss of active surface area due to particle agglomeration. The mesostructured thin films, therefore, unite the beneficial properties of both the nanoscale and the extended bulk systems, and lead to new design rules for producing highly active and durable electrocatalysts. These compositions and methods provide the ability to tailor the composition, morphology and structure of the thin-film-based Pt group metals at the mesoscale which allows the harvesting of maximal performance from the employed constituents.

The compositions and methods are a new class of mesostructured catalysts based on thin films with an adjustable composition profile and surface morphology. These materials are in the form of metallic thin Pt group metal films with properties that have been tailored to improve the activity for the ORR. The obtained ORR activity is the highest ever measured on non-bulk catalysts owing to the beneficial near-surface compositional profile and its highly crystalline surface morphology. The exceptional properties of this Meso-TF are comparable to extended single-crystalline surfaces and improvement factors in kinetic activity of 8 versus polycrystalline Pt and 20 versus Pt/C are observed. The substantial advances in catalytic performance are obtained through structural mesoscale ordering of the thin film induced by thermal annealing in a reductive atmosphere. The approach as developed can be applied to generate a wide range of (electro)catalysts with tailored structure/composition, ultralow precious metal content and superior functional properties such as activity and durability.

The following non-limiting examples illustrates various aspects of the composition and methods of the invention.

### EXAMPLE I

Thin metal films were deposited by planar magnetron sputter deposition on the ultrahigh-vacuum-cleaned surface of a mirror-polished glassy carbon substrate of 6 mm in diameter (base vacuum 1×10⁻¹⁰ torr). The deposition rate was set to 0.3 A by a quartz-crystal microbalance and an exposure of 7 s was calibrated for the nominal thickness of 2.2˜2.3 A for a monolayer of Pt. The film thickness was derived from the exposure time of computer-controlled shutters during deposition. The thickness of all thin films in this example was 20 nm. In the case of NSTF catalysts, consecutive layers of platinum and the transition metal, M, of choice were deposited onto the NSTF layer of oriented organic pigment (perylene red). Whiskers were also deposited by planar magnetron sputter deposition in vacuum. The deposition process covered each of the perylene red whiskers with a thin metallic film. Both the monometallic Pt and the Pt-alloy catalyst were obtained by this method. The Meso-TF were obtained by thermal annealing of NSTF at about 400° C. in a hydrogen-rich atmosphere. The temperature was increased in increments of 20° C. per 5 minutes, and the whole process lasted about 2 h.

### EXAMPLE II

An Autolab PGSTAT 30 with FI20, ECD, ADC and SCAN GEN modules was used for electrochemical measurements. Perchloric acid diluted with MilliQ water to 0.1 M was the electrolyte in all cases. The gases used were research grade (5N5+) argon and oxygen. In all experiments, a silver-silver chloride was the reference electrode. However, all potentials referred to in this paper are converted to the pH-independent reversible hydrogen electrode scale. All experiments were repeated 8 times to confirm reproducibility, and to improve the accuracy in the determination of kinetic activities. Kinetic current densities were obtained from the measured ORR polarization curves in accordance with the Koutecky-Levich equation:

I_{ORR}⁻¹I_{kinetic}⁻¹+I_{diffustion}⁻¹

The ECSA of the nanocatalysts was determined by integrating both the H₈₅ part of the CV profile, and the polarization curve obtained by oxidation of a monolayer of adsorbed carbon monoxide to avoid underestimation of the surface area due to altered hydrogen adsorption properties. All catalysts were deposited on a RDE made of glassy carbon, and the loading of the nanoscale thin-film catalysts was adjusted to be 60 μg, cm_{disc}⁻², whereas the loading for Pt/C obtained from TKK was 12 μg_{Pt} cm. Kinetic current densities as reported are normalized by ECSA in all cases.

### EXAMPLE III

A Hitachi H-9500 environmental transmission electron microscope operated at 300 kV was used to perform the microstructural characterization and in situ heating TEM study. Powder samples were attached to the heating zone of a Hitachi gas-injection-heating holder. Images of nanoparticles were first recorded at room temperature, followed by heating of the specimen inside the microscope chamber with a vacuum level of about 10⁻⁴ Pa. A CCD (charged-coupled device) camera was used to monitor the microstructural evolution and record images and videos. Each heating temperature was held for at least 10 mM for detailed structural characterization, including morphology and atomic structure. A Hitachi SU70 high-resolution field-emission SEM was used for routine nanoparticle sample inspection. For the detailed surface morphology study at the nanometre scale, a Hitachi S-5500 ultrahigh-resolution cold field-emission SEM delivered a much higher resolution power (0.4 nm secondary electron image resolution at 30 kV) than normal SEM because of the specially designed objective lens. On both SU70 and S-5500, secondary electron images were taken at 15 kV or 30 kV to reveal the surface morphology of both the as-deposited, as well as the annealed nanoparticles.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments, and with various modifications, as are suited to the particular use contemplated.

1. A method of manufacturing thin film catalysts, comprising the steps of:
providing a substrate;
providing a source of Pt group metal and alloying metal, M;
using physical vapor deposition to deposit the Pt group metal and alloying metal, M, as a thin film on the substrate; and
annealing the thin film until forming (111) hexagonal faceted surface grains in the thin film.

2. The method as defined in claim 1 wherein the alloying metal comprises a transition metal and the Pt group metal is selected from the group of Pt, Pd and Rh.

3. The method as defined in claim 1 wherein the annealing step comprises heating the thin film to about 300° -400° C. for about 30 minutes, thereby achieving the morphology of the (111) hexagonal faceted surface grains.

4. The method as defined in claim 1 wherein the substrate is selected from the group of a plurality of whisker shaped protrusions and a glassy carbon.

5. The method as defined in claim 4 wherein the plurality of whisker shaped protrusions consist of perylene red.

6. The method as defined in claim 2 wherein the transition metal is selected from the group of Fe, Co, Ni, V and Ti.

7. The method as defined in claim 1 wherein the physical vapor deposition comprises magnetron sputtering.

8. The method as defined in claim 1 wherein each of the whiskers include a plurality of whiskerettes and the annealing step comprises heating at a time and temperature until surface whiskerette surface irregularities are morphologically smoothed out.

9. The method as defined in claim 1 further including annealing until a stable Pt M alloy is formed in the (111) hexagonal faceted grains.

10. The method as defined in claim 9 wherein the PtM alloy comprises Pt₃Ni (111).

11. The method as defined in claim 1 further including the step of providing a reductive gas atmosphere during the physical vapor deposition.

12. The method as defined in claim 11 wherein the reductive atmosphere comprises a H₂ atmosphere.

13. The method as defined in claim 12 wherein the H₂ atmosphere includes an inert gas.

14. The method as defined in claim 1 wherein the Pt group metal comprises Pt, the M comprises Ni and the annealing step is performed until a cyclic voltammagram curve for a Pt₃Ni thin film mimics Pt (111) single crystal.

15. The method as defined in claim 14 wherein the annealing step includes a time and temperature which provides the thin film having an ORR-specific activity which is at least about 70% of Pt₃Ni (111) single crystal skin.

16. The method as defined in claim 1 wherein the thin film is deposited until thickness is between about 5-20 nm.

17. A thin film electrocatalyst comprising,
a PtM alloy, wherein M comprises a transition metal;
the PtM alloy thin film being disposed on a substrate and having a morphology of (111) hexagonal faceted grains and having an ORR specific activity which is at least about 70% of a Pt₃Ni (111) single crystal skin.

18. The thin film electrocatalyst as defined in claim 16 wherein the PtM alloy wherein M is selected from the group of Fe, Co, Ni, Vi and Ti.

19. The thin film electrocatalyst as defined in claim 17 wherein the thin film is about 5-20 nm thickness and has a CV plot which mimics Pt₃Ni (111).

20. The thin film electrocatalyst as defined in claim 17 wherein the substrate is selected from the group of a plurality of whiskers and a glossy carbon substrate.
